(19) United States
(12) Patent Application Publication
(10) Pub. No.: US 2013/0138508 A1
(43) Pub. Date: May 30, 2013

(54) Method and System for Media Content Delivery On a Display Device

(71) Applicant: Walter S. Gee, Oak Lawn, IL (US)

(72) Inventor: Walter S. Gee, Oak Lawn, IL (US)

(21) Appl. No.: 13/308,501

(22) Filed: Nov. 30, 2011

(51) Int. Cl. G06Q 30/02; H04W 8/00; H04W 4/02; G06F 15/16

(52) U.S. Cl. 705/14.58; 709/217; 705/14.49; 705/14.62

(57) ABSTRACT

A display device coupled with one or more electronic visual displays to present media content positioned in a vehicle for external viewing utilizing a transceiver communications element to deliver and receive information through communications networks while traveling in a vehicle. Additional embodiments are disclosed.

### BACKGROUND

There are methods in related art in which advertisements are delivered using vehicles. Many have advertisements painted on the surface of the vehicle body or some have displays mounted on a platform which is driven around. These advertisements or messages are static.

It would be desirable to have a dynamic method to present changing, updated and location specific advertisements and messages on vehicles.

The present disclosure provides an invention to deliver dynamically changing, updating and location specific advertisements and messages on vehicles as they travel by utilizing various communications networks, the internet and mobile communication devices.

### BRIEF DESCRIPTION

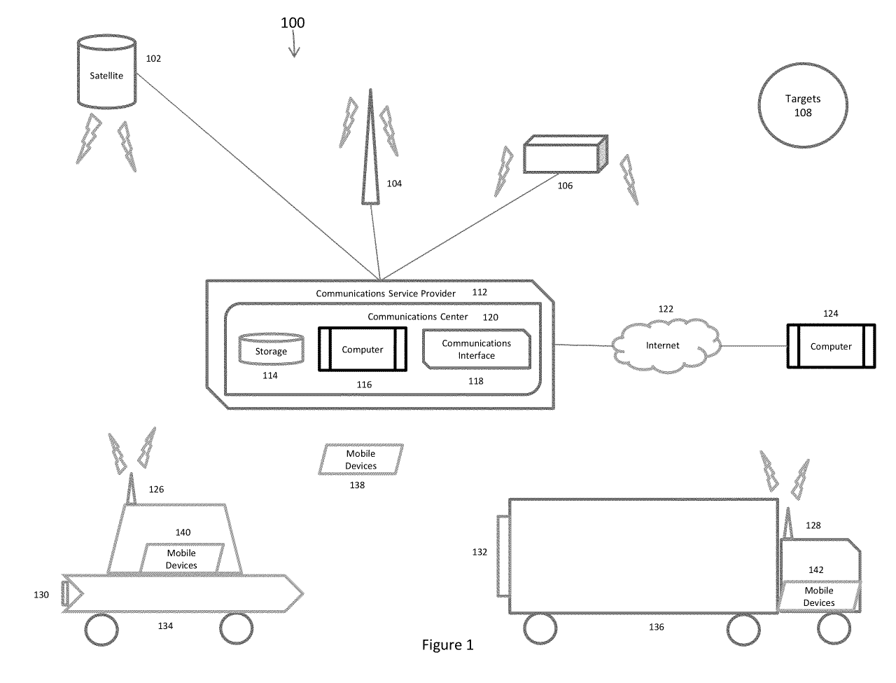

FIG. 1 illustrates an operating environment for delivering media content to display devices according to one embodiment.

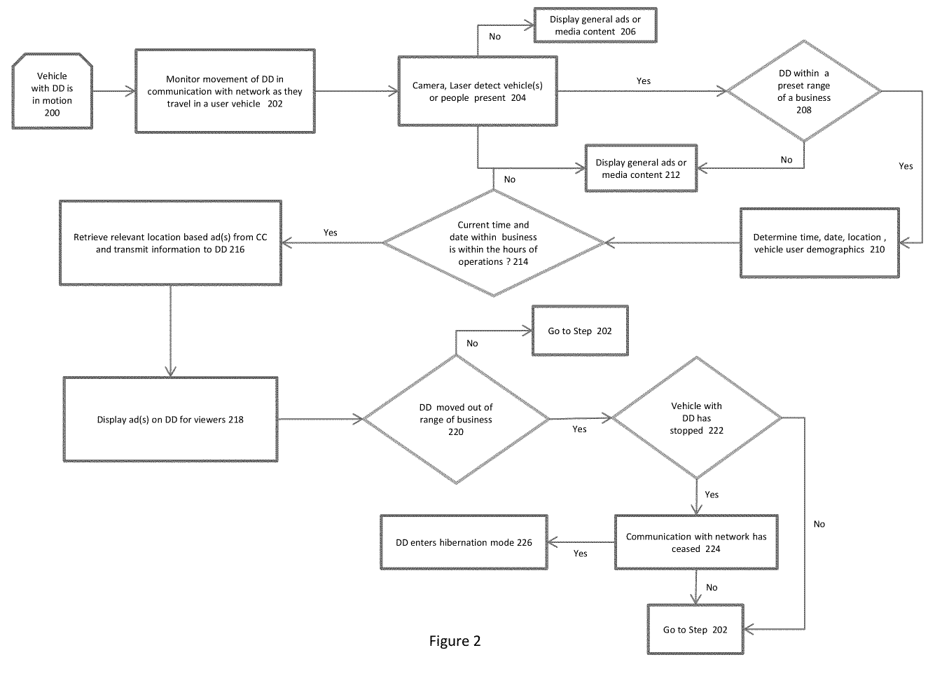

FIG. 2 illustrates an embodiment of a method for delivering media content to display devices.

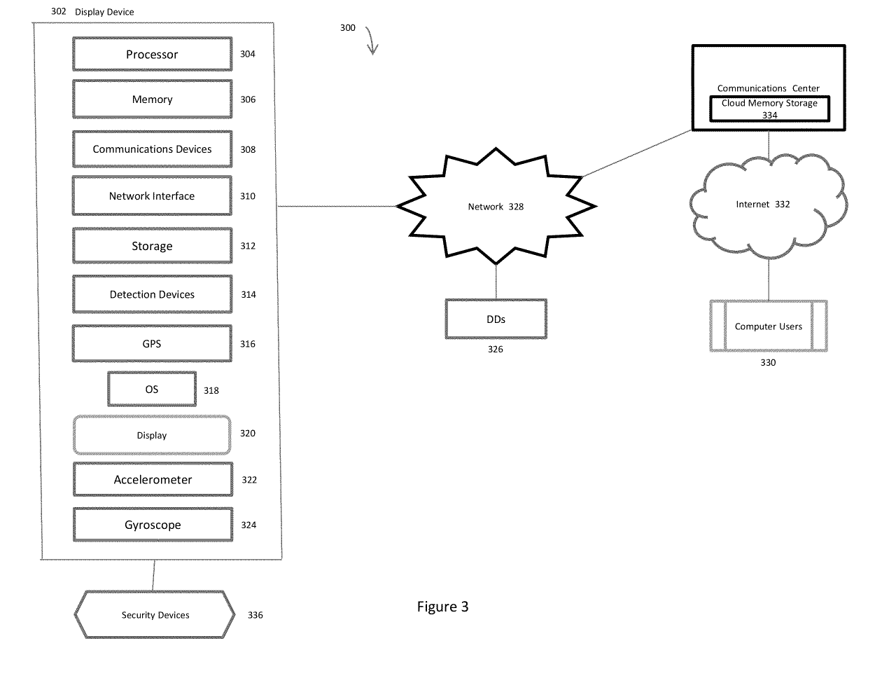

FIG. 3 illustrates a system for delivering media content to display devices according to one embodiment.

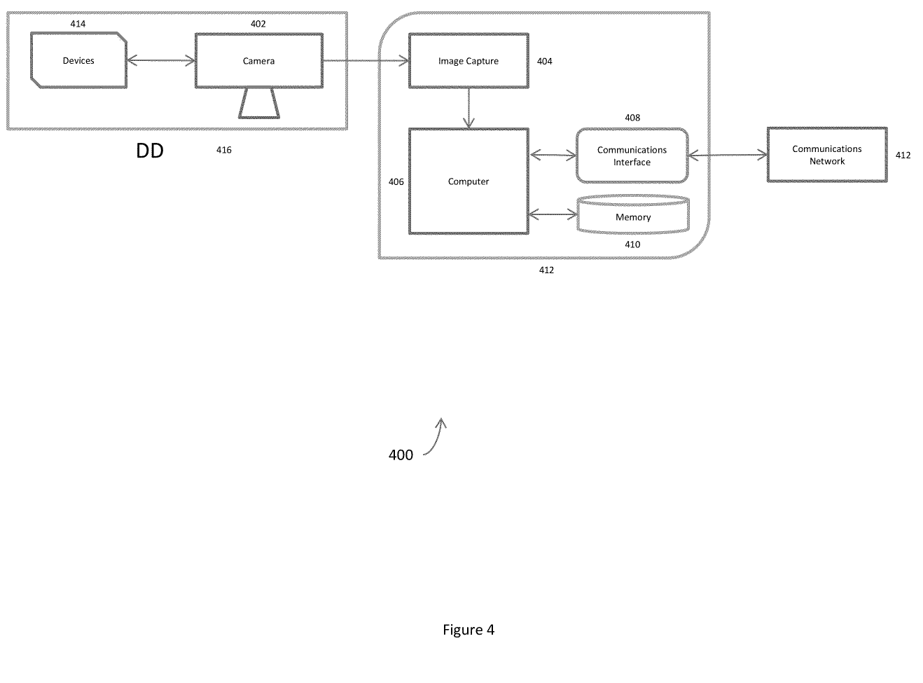

FIG. 4 illustrates an embodiment of the detection system.

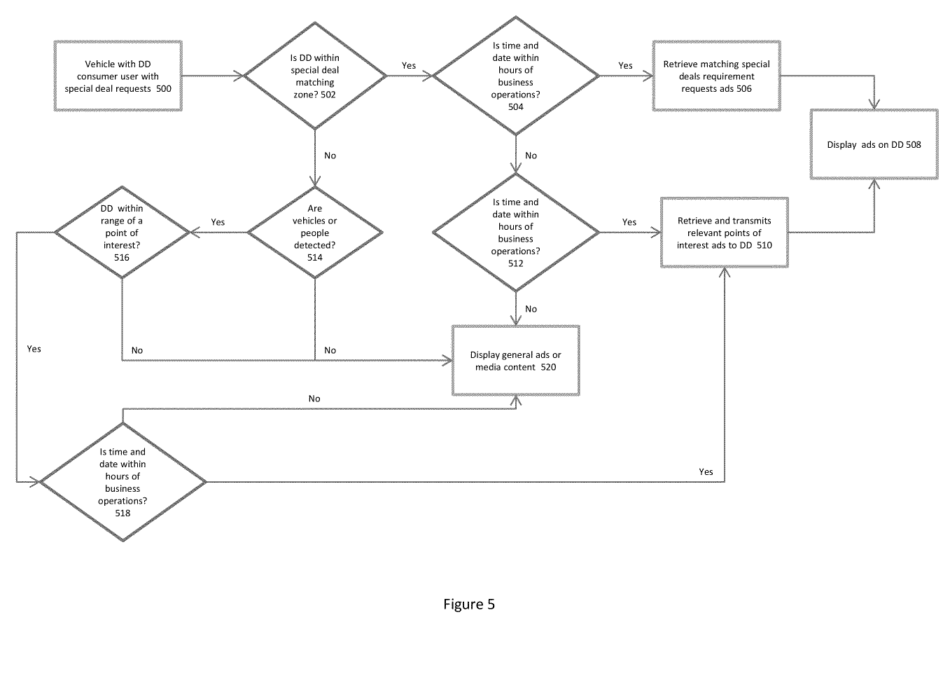

FIG. 5 illustrates an embodiment of a method for delivering location specific instant matching media content to display devices.

### DETAILED DESCRIPTION

In the following, reference is made to embodiments of the invention. However, it should be understood that the invention is not limited to specific described embodiments. Instead, any combination of the following features and elements, whether related to a different embodiments or not, is contemplated to implement and practice the invention. Furthermore, in various embodiments the invention provides numerous advantages over the prior art. However, although embodiments of the invention may achieve advantage over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to the invention shall not be construed as a generalization of any inventive subject matter disclosed herein and shall not be considered to be an element or limitation of the appended claims except where explicitly recited in a claim(s).

“Storage medium” as referred to herein relates to media capable of maintaining expressions which are perceivable by one or more machines. For example, a storage medium may comprise one or more storage devices for storing machine-readable instructions and/or information. Such storage devices may comprise any one of several media types including, for example, magnetic, optical or semiconductor storage media. Such storage devices may also comprise any type of long term, short term, volatile or non-volatile devices memory devices. However, these are merely examples of a storage medium and claimed subject matter is not limited in these respects.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

The present invention as discussed herein generally provides a method, system and device for distributing media content such as advertisements, or a media content delivery system conveying advertisements or other paid informational messages using display devices coupled with electronic visual displays while traveling in a vehicle. In embodiments, a display device as referred herein relates to a device which may include without limitation a location device such as a GPS receiver, a processor, memory, a non-transitory computer readable medium storage, software, computer control logic, one or more databases, at least one electronic visual display, a communications interface, and a display interface. A display device is a device with suitable hardware and software necessary to process information including without limitation location information, and to select and transmit media content such as advertisements to one or more displays for presentation. A display device may couple with other devices including without limitation a location device, a detection device, electronic visual displays, mobile devices, cameras, sensors, lights, accelerometer, gyroscope, and security devices among others. A display device may be integrated with suitable hardware and software to function as a media content distribution server. A display device may include only portions of the full suite of components necessary to function as a media content distribution server, and couple with other components externally. Together the display device coupled with suitable external components may function as a media content distribution server. A display device may include without limitation a computing device with suitable hardware and software, or a computing device coupled with external components containing suitable hardware and software. A mobile device including without limitation a smartphone, a cell phone, a cellular device, a satellite device, a personal display assistant (PDA), a portable computer, and a tablet computer may be able to perform the functions of a display device if the mobile device contains suitable hardware and software, or is coupled with external components containing suitable hardware and software. With suitable hardware and software within or coupled with it, a computing device or a mobile device may function as a media content distribution server. A display device may comprise of an integrated unit containing suitable hardware and software to function as a media content distribution server with capabilities to couple with external hardware and software such as external electronic visual displays, external computing devices, or external mobile devices.

FIG. 1 depicts an embodiment of a system of delivering media content such as advertisements to a display device (DD) on vehicles in an operating environment comprising of a satellite communications network 102, cellular communications 104 and a wireless communications network 106 and is generally designated as 100. The wireless communications network 106 could include but not limited to a WiFi or wide area network (WAN) communications network. System 100 includes a communications center 120 which contains a communications interface 118 with the capabilities to connect and exchange data information from one or more satellites 102, one or more wireless carrier systems 104 and 106. A computer system 116 is coupled with a storage 114 which exchanges, analyzes and stores data information obtained through one or more satellites 102 or from one or more wireless carrier systems 104 and 106 via a connection through the communications interface 118. The communications center 120 is also able to communicate with the internet 122 and users with internet access 124 through the communications interface 118 through one or more communications service providers 112. Targets 108 include without limitations businesses, events, venues, and points of interests.

Although depicted in FIG. 1 as a car and a truck, vehicles can include but not limited to cars, buses, trucks, passenger trains, cargo trains, ferries, animal driven vehicles, aircrafts, freight cars, trailers, airplanes, helicopters, boats, ships, ATVs, skidoos, motorcycles, bicycles, scooters, farm equipment, vans, light trucks, cargo trucks, freight trucks, freight containers, truck freight trailers, construction equipment, golf carts, airships, recreational vehicles (RVs) and balloons.

In an embodiment, DD 130 or 132 communicates through a mobile telecommunications network utilizing common circuit mode channel access methods such as GPRS, EDGE, EV-DO, CSMA, MACA, GSM, CDMA, FDMA, SDMA, TDMA, LTE Advanced among others, then through a router, switch or modem, etc. are coupled to the wireless satellite system 102, wireless cellular system 104 and other wireless systems 106. Other wireless systems 106 could include but not be limited to WiFi, wide area network (WAN), WiMAX or a combination of such wireless systems.

The communications center 120 coupled with a communications service provider 112 is comprised of any suitable hardware and/or software systems or collection of systems capable of connecting wireless carrier systems 102, 104 and 106 to provide communication services to the DD 130 and 132 in vehicles 134 and 136.

In an embodiment, media content and advertisements can be entered and uploaded by users with internet access 124 such information maybe in the form of graphics data file, text data files, audio data file, video data files or other types of data files. Media content and advertisements could be stored in an internet cloud memory system 334 and accessed via the internet 122. As depicted in FIG. 1, a communication service provider 112 may connect with one or more satellite communications network 102, one or more cellular communications network 104 or one or more WiFi communications network 106 and utilize the communications network which would provide the best signal and cost benefit. Other communications networks may also be utilized. Other methods of media content and advertisements storage and updating are also possible. One method would include but not be limited to having media content and advertisements stored locally on the DD using memory storage and have the data updated by exchanging removable memory cards or other portable removable memory devices. Updating the data could also be done by wireless data exchange. Another method of media content and advertisement storage would utilize a client-server data storage system with internet access. The communications center 120 could send information to a DD with local memory storage to select the advertisements and/or media content to be presented by the DD.

In an embodiment, vehicles 134 and 136 are affixed with a display device (DD) 130 or 132 with communications interface 126 and 128. Although depicted as separate units, the DD 130 and communications interface 126 as well as DD 132 and communications interface 128, could be a single integrated apparatus. The DD 130 or 132 comprise of a display, computer, global positioning system (GPS) receiver, memory, accelerometer, gyroscope, storage, communications devices, network interface, database and detection devices. It can communicate with the communications interface 126 and 128 by using IEEE 802 standards such as WiFi, Bluetooth or by direct wired link such as Ethernet. It can be powered by batteries, vehicle power or solar power. Each DD can communicate wirelessly with other DDs via their communications interfaces.

In an embodiment, the DD can communicate with smartphones, mobile communications devices or with an interior electronic visual display to present media content to the interior of a vehicle. Also, media content retrieved for presentation at the DD may also be sent to the vehicle's occupants' mobile devices via text message or other messaging methods depending on the occupants mobile device type and media capabilities. Vehicle occupants can subscribe to such as service online, by phone, text messages or other methods.

In an embodiment, the DD electronic visual display used for advertisement or media content presentations can be flexible, bendable, various thickness, various sizes, various shapes, and powered by solar, vehicle power and/or battery powered. The display could be a light emitting diode (LED), liquid crystal display (LCD), plasma, amorphous TFT or other types of electronic visual displays. Although the DD 130 or 132 are depicted in FIG. 1 as being rear mounted, their placement and location on a vehicle can be placed at any external or internal position in a vehicle to target external or internal viewing audiences. Each DD may have one or more electronic visual displays coupled to it and mounted in various locations on a vehicle for viewing audiences outside or inside the vehicle with the DD. The display will be capable of presenting alphanumeric text, graphics and videos. The DD and electronic visual display will be multilingual. A DD will be able to communicate with other DD which are within a predetermined distance. The DD 130 and 132 are able to communicate with each other as well as with other mobile devices 138, 140 and 142 which are within a predetermined distance. Mobile devices 138, 140 and 142 could be any communications devices capable of exchanging audio, video, or data communications over the network 328 with other mobile devices. Mobile devices may include, but are not limited to mobile cellular phones, personal digital assistants (PDAs), portable computers and tablet computers. Mobile devices 138, 140 or 142 which have wireless internet access can access their media content accounts via the internet 122.

In an embodiment, the DD will utilize computer software with algorithms and logic to determine if and when the DD is in motion and if and when it is within a predetermined distance from one or more businesses or points of interest, if other vehicles, people or other DDs are within a predetermined range of the DD. Once the DD 130 or 132 detects motion by the GPS receiver, accelerometer or gyroscope; the DD switches on automatically and begins to track and monitor the location of the DD and communicate with the communications center 120. Once the DD is activated by motion as detected by the GPS receiver, accelerometer or gyroscope, the location information of the DD 130 and 132 will be continuously transmitted to the communications center 120. Advertisements and media content will also be continuously retrieved and delivered through the communications center 120 and communications networks to the DD until the vehicle engine is switched off When the DD is in motion or if other vehicles or people are detected within a predetermined range of the DD 130 and 132, the DD 130 or 132 will send location and other information to the communications center 120 via wireless communications networks 102, 104 or 106. Based upon the information received from DD 130 or 132, the communications center 120 will requests advertisements and/or media content from the internet cloud memory system 334. The advertisements and/or media content are retrieved from the internet cloud memory system 334 and routed through the communications network 102, 104 and 106 to the DD 130 and 132 to be presented on the electronic visual display 320 for external viewing audiences. If the vehicle 134 or 136 with the DD 130 and 132 are within a predetermined range of one or more targets 108 who have purchased advertisements or media content for their organizations and the detection devices 314 have sensed the presence of other vehicles or people within a predetermined range of a DD, then the time and date are checked. If the time and date are not within the hours of operation of the one or more targets 108 detected, then one or more general advertisements or one or more media content will be retrieved by the communications center 120 from the internet cloud memory system 334. If the time and date are within the hours of operation of one or more targets 108, then one or more advertisement or media content associated with the one or more targets 108 will be retrieved and presented for display at the electronic visual display 320 for external viewing audiences. Otherwise, one or more general and less specific advertisement and/or media content may be retrieved from the internet cloud memory system 334 for presentation for the DD 130 and 132. The communications center will have the capabilities to detect communications signals from satellites and cellular antennas or other communications access points and will utilize software to allow automatic switching among communications carriers depending on communications signal strength and signal degradation.

Since each DD can communicate with other DDS, advertisements or media content delivered to a display device can also be forwarded to other display devices which are within a predetermined range. Advertisements or media content delivered to a display device can also be forwarded to other mobile communications devices which are within a predetermined range and are subscribed to the service.

In an embodiment, software can also monitor the travels of the plurality of display devices and is able to map their locations, disable their use or erase data in their memory remotely. This would be useful for security purposes and media content targeting and selection. General information may also be delivered to the DD such as traffic information, alerts, weather or public service information. Specific advertisements and/or media content can be retrieved and delivered to DDs based on the analysis by the communications center 120 of the travel information of a DD and other information such as the subscriber's demographic information. Some examples may include but not be limited to the monitoring of the number of miles travels, time traveling, vehicle information, time of day, the date; all of which could trigger specific advertisements and/or media content to be presented to DDs within a predetermined range of the target DD that could promote food establishments, fueling stations, rest stops, hotels, grocery stores, shopping centers or recreational parks. Such advertisements and/or media content will be retrieved and delivered to DDs by the communication center 120 based on a variety of information including but not limited to location of the DD, display device owner demographics, travel information of the DD, and the locations of targets 108 with advertisements and/or media content.

In an embodiment, software and algorithms can also be developed to create instant matching advertisements or media content when a DD is at a particular location. As an illustrative example, a consumer user or subscriber of the DD system, could enter information regarding special deals or particular subject matters the consumer user or subscriber may be interested in, for example, they may include but not be limited to, special deals for a car motor oil change, special deals for a seafood dinner, special deals for a hotel room, to locate a theater, to find a special deal on a 2 door blue sports car of a particular brand or to locate a dentist and so forth. These special deal requirement requests maybe entered into the DD system by a mobile device including but not limited to a cellular phone, smart phone, PDAs, tablet computers, portable computers or any device which has internet access. Mobile phone users may also enter such special deal requirement requests by sending a short message system (SMS) text message or by accessing a communications center by calling. A business user or subscriber may enter data and information which would allow for generation of instant special deals when a plurality of DDs are within a predetermined range of a particular location at a particular time and at a particular date. The data and information entered by the business or users for their special deals or media content can offer a variety of variables and parameters including but not limited to pricing, expiration time, number of deals, alternative special deals and so forth. Therefore, when a user or subscriber with a DD is within a predetermined range of a particular location, software at the communications center 120 will be able to automatically generate instant matching special deal advertisements or media content for presentation by the plurality of electronic visual displays of DDs which are within a predetermined range of the particular location to target users and/or subscribers of the DD who possess the interests for those special deals or particular subject matters or to target vehicles with a DD who possess interests for those special deals or particular subject matters or to target other subscribers to the DD service external to the vehicle with the DD who possess the special interests for those deals or particular subject matters. The consumer user or subscriber of the DD system may specify any number of different criteria, parameters or variables regarding the special deals or particular subject matters of interests and the software algorithms may be able to match them with the information and criteria a business user or subscriber may enter into the DD instant advertisement or media content matching system. For example, the consumer user or subscriber of the DD may only desire to have an interest in such deals for a particular time of day, a particular price range or a particular period of time before the user or subscriber's interest will cease, that is, there is an expiration time for the interest. The instant matching special deals or media content could be generated with and delivered to a plurality of DDs at a predetermined range around the location of where the special deals or particular subject matter is located. The location specific instant matching advertisements or media content will allow a business user or subscriber to fulfill the requirements of requests for special deals or requests for a particular subject matter of interest a consumer user or subscriber of the DD service desires. Parameters or variables of the location specific automatic matching special deals could be entered in freeform or by filling a form by users of the DD system. Software will be able to decipher a user's special deal requirement request. The software will utilize search algorithms to locate matches with the information provided by a business user or subscriber wishing to provide fulfillment of the special deal requirement requests.

Location specific advertisements or media content delivered to a DD will occur when the DD is within a predetermined range of a plurality of targets 108. Some conditions which would trigger location specific advertisements or media content delivery would include but not be limited to when the DD traveling in a vehicle is within a predetermined distance of a plurality of targets 108 and it is within the hours of operation of the plurality of targets 108, and wherein the media content retrieved is stored in an internet cloud memory system or storage system accessible by the internet. Although general advertisements or general media content may be delivered to a DD when the DD is not within a predetermined distance of a plurality of targets 108, location specific advertisements or media content may be delivered if software determines the DD is approaching one or more locations which have a plurality of targets 108 with advertisements or media content ready for delivery and the time and date are within the hours of operations of the plurality of targets 108, and wherein the media content retrieved is stored in an internet cloud memory system or storage system accessible by the internet.

Software may be used to generate dynamic advertisements and/or media content based on a DD consumer users input of special deal requirement requests or a plurality of specific subject interest requests, and the input of DD business users or other DD users willing to fulfill the consumer users requests. Based on the parameters, descriptions, variables and other data, software could generate dynamic advertisements and/or media content for presentation on a plurality of DD. For example, a consumer user enters the special deal requirement request for a new, black, 4 door, Lexus sedan, priced less than $30,000, Miami, Fla. and a business user may enter the willingness to sell a used, black, 4 door, Acura sedan for $20,000, Miami, Fla. Therefore, based on the information provided, advertisements may be generated for the Acura to be presented on DDs within a predetermined range of the consumer user despite the less than complete match for the consumer's special deal requirement request. Another example would be a consumer user begins travel at 9 AM in nice calm sunny weather but 3 hours later is approaching a severe weather storm. The communications center 120 would then be able to generate weather alerts and also select advertisements which may offer shelter such as shopping centers or hotels to be delivered to DDs.

Depending on the capabilities of the electronic visual displays coupled with the DDs, special effects, graphics, logos or videos may also be selected or delivered to a DD within range of the consumer with the special deal requirement request. Software could also combine or package multiple advertisements in multiple forms such as graphics, texts or other forms and deliver codes such as QR codes for special deals in the advertisements.

FIG. 2 illustrates an embodiment of a method of advertising to a portable mobile display DD on vehicles. At step 200, the global positioning system (GPS) receiver 316, accelerometer 322 and gyroscope 324 in the DD monitors the movement of DD while it is in continuous communications with the communications center 120 through the communications networks as the DD travels in a vehicle. The communications center 120 can determine the locations of DD from the longitude and latitude information from the GPS receiver or by way of a common 2-D trilateration technique using radiofrequency telemetry delivered by the wireless antenna tower in a cellular network system or by simple mathematical principle called 3-D trilateration with 3 or more satellites and the earth. The communications devices 308 in a DD can be programmed to automatically switch from cellular antennas to satellites or to another communications network as necessary due to signal degradation or signal loss to permit the continuous monitoring of the location of the DD. The communications devices 308 will also transmit location information to the communications center 120 and the delivery of advertisements and/or media content to DD when required. Wireless access points can also be used to determine location within a network such as a wide area network (WAN) or other wireless networks.

At step 202, the DD sends its GPS derived location information to the communications center 120, while the accelerometer 322 and gyroscope 324 in the DD are also able to detect the motion of the DD. GPS derived location information of DD are continuously sent to the communications center 120 once motion of the DD is detected. If the vehicle is switched on but there is no movement, then the detection devices 314 determine the presence of other vehicles or people at step 204. The detection devices 314 are continuously sensing the presence of vehicles or people within a preset range of the DD. The accelerometer 322, gyroscope 324 and detection devices 314 can be integrated in the DD or operate as separate units. If no other vehicles or people are sensed or detected to be present within a predefined range of the DD, then general advertisements are retrieved from the communications center 120 as shown at step 206. If vehicles or people are detected to be present within a preset range of the DD, then the communications center 120 determines if the location of the DD is within a predetermined range of one or more targets 108 at step 208. If affirmative, then the time and date is checked to ensure it is within the hours of operation for a given business or point of interest at steps 210 and 214. If the current time and date are within the hours of operations, then one or more location based associated advertisements or one or more media content for the one or more targets 108 will be retrieved by the communication center 120 and delivered to the DD at step 216 for presentation at the electronic visual display 320 for external viewing at step 218. If the vehicle continues in motion and the detection devices 314 have sensed the presence of one or more vehicles or one or more person to be within a predetermined distance but the DD is not within the range of targets 108, then one or more general advertisements or one or more media content maybe retrieved by the communications center 120 from the internet cloud memory system 334 and delivered to the DD. If the DD is within a preset range of one or more targets 108 but the current time is outside the hours of operation, then one or more general advertisements or one or more media content will be retrieved by the communications center 120 from the internet cloud memory system 334 to be presented by the electronic visual display 320 by the DD. If the DD is within more than one targets 108 and within the hours and dates of operations, the communications center will retrieve all relevant location based advertisements and/or media content but will deliver advertisements and/or media content based on the advertisement or media content purchase level of priority.

In an embodiment the service level of advertisement or media content is determined by the service price levels a business user or subscriber is willing to pay to achieve a higher service priority. This tiered purchase system will allow users to gain higher priority for their advertisements or media content. Priority levels will determine the frequencies of an advertisement will be selected and delivered to DD as well as the delivery probabilities of an advertisement or media content. All such determination may be under the control of computer software algorithms operating at the communications center 120.

As an illustrative embodiment, an advertisement or media content is retrieved based on a service level agreement that is associated with the targets 108. There may be multiple service levels based on a tiered purchase system, for example, a user may choose a price level which allows their advertisements or media content to be presented on the DD when the predetermined distance range to the DD is at the higher end of the range thus increasing its frequency and probability for service, length of service or type of service. Alternatively, a user may choose a price level which allows their advertisements or media content to be presented on the DD when the predetermined range to the DD is at a lower end or the range thus limiting and decreasing its frequency and probability for service, length of service or type of service. The type of service may include the form of the advertisement of media content to be presented on the electronic visual display. This may include but not limited to the colors used, text, graphics or videos, the mode (constant, blinking, scrolling, different colors, etc.) of the text or graphics among others.

In an embodiment the advertisements and/or media content retrieved by the communications center 120 and delivered to a DD will result in the compensation for each advertisement and/or media content presented on the DD for external viewers. Compensation will be distributed to either or both the vehicle owner or the DD owner. Compensation will be determined by software stored in the communication center 120 and will be distributed at a predetermined regular interval.

Step 220 determines if the DD continues to be within a predetermined range of targets 108. If DD continues to be within range of one or more targets 108, then it moves to step 202 as DD will continue to monitor their location via their GPS receivers and continue to sense the presence of one or more vehicles or one or more persons within a predetermined range of the DD. Once the DD has moved out of range of all the targets 108 and the DD continues to be in motion, the will continue to communicate with the communications center 120 and send its location information, the detection devices 314 are continuously scanning for vehicles or people within a preset range of the DD as depicted at step 222. Once the DD is no longer in motion, the DD communications with the network and communications center 120 is determined to be active or not. If DD remains actively communicating with the network and communications center 120, then it returns to step 202. Once the DD have stopped communicating with the network and the communications center 120, then the DD will enter an inactive state of hibernation or power off.

Computer software can be employed at the communications center 120 to track the movement, locations of all active DD at all times and retrieve and deliver relevant business, points of interest or demographically matching location based advertisements and media content to DDs. For example, the computer software after analysis may determine that a vehicle with an active DD has a particular demographics such as age, gender, income level, education, work information, home information, vehicle information, time, date, personal information, and deliver advertisements or media content which are more relevant and targeted such as a particular special deal for their vehicle, special offers because of someone's special day in their family, gift suggestions, job offerings, nearby by hotels if their travel times and distance and time of day are all tracked, food establishments based on their travel times, distance, time of day. This is one particular embodiment of such a computer software algorithm many other embodiments are also possible which are not listed.

FIG. 3 illustrates display devices (DD) 302 and 326 interconnected according to an embodiment. The overall structure in an embodiment of a display device (DD) 302 as presented on vehicles 134 and 136. Display device (DD) 302 represents DD 130 and 132 with additional detail. A typical DD 302 comprises of a processor 304, memory 306, communications devices 308, network interface 310, storage 312, detection devices 314, operating system (OS) 318. One or more electronic visual displays 320, accelerometer 322 and gyroscope 324. The DDs 302 and 326 communicate through a communications network 328. The communications network 328 can include, but not limited to a satellite communications network 102, a cellular communications network 104 or a wireless communications network 106. The communications network 328 is connected to the internet 332 which can be accessed by one or more users 330.

Communications network 328 may be a wireless network, a wired network or any combination of wireless network and wired network. For example, network 328 may include but be not limited to one or more of a fiber optics network, a passive optical network, a cable network, an Internet network, a satellite network (e.g., operating in Band C, Band Ku or Band Ka)), a wireless LAN, a Global System for Mobile Communications (GSM), a Personal Communication Service (PCS), a Personal Area Network (PAN), D-AMPS, WiFi, Fixed Wireless Data, IEEE 802.11 (a, b, g, l, n) or any other wired or wireless network for transmitting and/or receiving a data signal. In addition, network 328 may include but without limitation, telephone line, fiber optics, IEEE Ethernet 802.3, a wide area network (WAN), a local area network (LAN), or a global network such as the Internet. Also, network 328 may support, an Internet network, a wireless communication network, a cellular network, or the like, or any combination thereof Network 328 may further include one, or any number of the exemplary types of networks mentioned above operating as a stand-alone network or in cooperation with each other. Network 328 may utilize one or more protocols of one or more network elements to which it is communicatively coupled. Network 328 may translate to or from other protocols to one or more protocols of network devices. Although network 328 is depicted as one network, it should be appreciated that according to one or more embodiments, network 328 may comprise a plurality of interconnected networks, such as, for example, a service provider network, the Internet, a broadcaster's network, a cable television network, corporate networks, and home networks.

In an embodiment, detection devices 314 could be one or more cameras and software configured to sense the presence of other vehicles or people. Biometric and 3-D facial recognition software and algorithms could be used. Other sensors can also be utilized including radar, lasers, infrared devices or radio frequencies. The one or more detection devices 314 are used to determine the presence of other vehicles or people within a predetermined range of the DD 302. The one or more detection devices 314 could be separate units and strategically placed to optimize detection.

In addition to the use of cameras for detection of vehicles and people external to the vehicle with the DD, one or more cameras could be used for security purposes. A plurality of cameras could be positioned or repositioned remotely for interior and exterior viewing, take photos or videos and deliver the photos or videos to a DD subscriber's mobile communications device or to the communications center 120. A DD could be coupled with security devices 336 including but not limited to an alarm system, sensors and flashing lights. The cameras, security devices in conjunction with location elements such as a GPS receiver would provide various security information including but not limited to photos, videos and location information.

Although the electronic visual display 320 as shown in FIG. 3 is an integrated component of the DD 302, the electronic visual display 320 could also be a separate unit from the DD 302, but interconnected, linked or otherwise coupled with the communications devices 308 to receive media content or advertisements for presentation for viewers. One or more electronic visual displays 320 could be strategically positioned and placed on a vehicle to optimize viewing by external audiences.

In an embodiment, processor 304 is implemented as a microcontroller, controller, host processor or communications processor. In an example, processor 304 is implemented as an application specific integrated circuit. In another embodiment, processor 304 is implemented as a processor coupled with a a central processing unit performing the function of a general purpose processor. The GPS unit 316 provides longitude and latitude coordinates of the DD responsive to a GPS broadcast signal received from one or more GPS satellite broadcast systems. Multiple GPS systems can be utilized for more accurate location information determination including but not limited to GLONASS, Galileo, QZSS, IRNSS and Beidou.

Processor 304 executes various computer programs that control programming and operational modes of electronic and mechanical systems with the DD 302. Processor 304 controls communications between DD 302 and one or more other DD units, one or more satellite communications systems 102 and one or more wireless carrier systems 104 and 106. Additionally, processor 304 controls, generates and accepts signals and data transmitted between DD unit 302 and the communications center 120. Processor 304 is part of the DD which executes instructions of a computer program, to perform the basic arithmetical, logical, and input/output operations of the system. It can be an off the shelf processor from any number of manufacturers or a customized processor developed to optimize the performance of the DD.

The electronic visual display 320, could be a light emitting diode (LED), liquid crystal display (LCD), amorphous TFT, plasma or any other type of electronic visual display able to present media data for external viewing. In an embodiment, one or more electronic visual displays could be mounted on a vehicle. The electronic visual displays could be mounted on the exterior or interior of a vehicle. The electronic visual displays could be portable and removable to allow relocation on a vehicle. One or more displays could also be viewed by occupants of a vehicle.

The DD 302 is generally under the control of an operating system (OS) 318. Some examples of OS 116 318 include Linux distributions, UNIX distribution, Microsoft Windows versions, Google Android, Apple iOS or Apple Macintosh OS versions. More generally, any OS 318 supporting the functions disclosed in this invention may be used.

The memory 306 and storage 312 operate together to perform various functions. Memory can be a random access memory sufficiently large to hold the necessary programming and data structures of the invention. Memory 306 can comprise a plurality of modules and that memory 306 may exist at multiple levels, from high speed registers and caches to lower speed but larger DRAM chips. Memory 306 may have control logic and dynamic device data stored in one or more data structures and may include dynamically changing information about the DD 302 such as velocity, direction of movement, orientation of the device and electronic visual display 320, temperature, longitude and latitude. Such information could be used to determine how media content is presented on the electronic display device 320.

The communications devices 308 can communicate with other devices utilizing any of the IEEE 802 protocols and standards such as IEEE 802.1 to 802.23 which include Ethernet, WiFi, WiMAX and others. They can communicate with mobile phone standards such as 3GPP family, EDGE, UMTS/UTRA, CDMA, UMB, LTE, EV-DO, mobile WiMAX, HSPA+ and LTE Advanced among many others. In an embodiment, the communications devices 308 for satellite communications transmits radio signals using spectrum around 1610 MHz (L-band) for uplinks and 2490 MHz (S-band) for downlinks. CDMA, FDMA and TDMA multiple access methods are possible with satellite communications.

The network interface device 310 may be any entry or exit device configured to allow network communications between the DD 302 and the communications network 328. The network interface device 310 could be a network adapter or other network interface card (NIC).

The storage 312 can be a direct access storage device (DASD). Although it is shown as a single unit, it could be a combination of fixed and/or removable storage devices such as fixed disk drives, tape drives, solid state drives, flash memory drives, floppy disk drives, removable memory cards or optical storage. The memory 306 and storage 312 could be a part of one virtual address space spanning multiple primary and secondary storage devices. Storage 312 contains various applications to perform a variety of functions including communications, advertisement and media content selection as well as control logic. Advertisements and media content will also reside in one or more data structures in storage 312.

In an embodiment the computer users 342 can be any user or subscriber who can access their accounts to upload media content or advertisements. A typical user account will have payment information, home and/or business information, personal information such as age, gender, interests, education, vehicle information, advertising account information among other data. Using an internet cloud memory system 334 is one possible way to store media content and advertisements uploaded by a user or business. Other methods of storage are also possible including the utilization of separate server and databases coupled to a network such as the internet. Cloud computing using the internet cloud memory system 334 is preferable as it is more scalable, reliable, secure, cost effective and allows for device and location independence. Maintenance is also easier with cloud computing. However, advertisements and/or media content could be stored locally at a DD and updated by exchanging memory storage devices including but not limited to memory cards, flash drives, external hard drive and other portable memory devices. Storage could also be updated by the wireless connections as well. The communications center 120 could send information to a DD to provide information as to which advertisements and/or media content should be presented.

FIG. 4 illustrates an embodiment of a camera sensing system 400 to scan an external area around the location of a display device (DD) to detect the presence of other vehicle or people. The camera sensing device 402 is integrated with a DD 416 in this illustration and through the use of artificial intelligence, expert system or other algorithmic software images are analyzed and processed to determine the presence of other vehicles or people. It is also possible to sense the presence of vehicles or people using other detection methods and devices such as infrared, radar, sonar, laser and radio frequencies. The detection software could be contained at the camera sensing system 400 or it could also be contained at the communications center 120.

In an embodiment, the camera sensing unit 412 will contain the software necessary to decipher images and determine the presence of vehicles or people within a predetermined range of the DD. The camera sensing device 402 is integrated with the DD 416 in this embodiment, although the camera sensing device 402 could be an independent unit from the DD but coupled with it. Camera 402 is coupled to image capture device 404 which is linked to a computer 406, memory 410 and communications interface 408. The computer 406 operates with a memory 410 and communications interface 408. Images captured by the camera sensing device 402 will be stored in memory 410. The images captured files could also be sent to the communication center 120 for processing and analysis for the presence of vehicles or people in the images. The memory can be a disk drive and database to store images captured for processing. The memory may contain artificial intelligence or expert system software to decipher and process images capture to determine the presence of vehicles or people based on predetermined software algorithms. Once vehicles or people are detected to be present and within a predetermined range of the DD 416 such information will be processed at the communications center and location based advertisements and/or content media will be retrieved from the internet cloud memory system 334 or other advertisement or media content storage devices. The advertisements and/or media content retrieved will be delivered via the network to the DD for presentation at its display for external viewers.

FIG. 5 illustrates an embodiment of a method of location specific instant matching advertising to a display device (DD) traveling in vehicles.

At step 500, a vehicle is traveling with a DD system subscriber who has placed a plurality of special deal requirement requests or a plurality of specific subject interest requests. As the DD is continuously monitoring the location of the DD as the subscriber is traveling, it is also analyzing whether location specific special deals information uploaded to the DD system by business users match the request requirements by the DD consumer user. This is done at step 502. If the DD consumer user's vehicle is within range of a business which has a match for a special deal, then the time and date are analyzed at step 504 to determine if it is within the business hours of operations. If affirmative, then since the DD is communication with other DDS within a predetermined range, once those DDs detect the presence of the DD consumer user with the special deal request, will have advertisements with information about the special deal and its location delivered for presentation on their electronic visual displays. The communications center 120 as it can monitor the locations of all DDs, may be able to determine which DD is located within the consumer user with the special deal request and deliver advertisements matching the desired special deals to DDs within a predetermined range or the consumer user with the special deal request. The DD within the consumer user's vehicle may also send information to the consumer user's internal DD, if present, or to the consumer user's mobile communication devices, if present.

If the time and date are outside of the hours of operations of the business with the special deals, then general advertisements will be displayed as depicted by step 512 and step 520.

If the DD consumer user is not within the range of a matching special deal requirement requests or a specific subject interest requests, then the DD will determine the presence of other vehicles or people at step 514 and if it is affirmative, then the communications center 120 will determine if the DD is near a point of interest or business at step 516. If it is not, then general ads will be delivered to the DDs within a predetermined range of the consumer user's vehicle 520. If a point of interests are within range, then the time and date will be analyzed 518. If the time is not within hours of operation of targets 108 then general advertisements will be delivered to the DDs. Otherwise, relevant advertisements or media content will be delivered to the DDS within a predetermined range of the consumer user 510 and 508.

The machine may comprise a server computer, a client user computer, a personal computer (PC), a tablet computer, a laptop computer, a desktop computer, a control system, a network router, a switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

Additionally, a consumer subscriber's special deal requirement requests or specific subject interest requests matching could occur by delivering messages indicating a match has occurred. Messages could be delivered to a consumer subscriber's mobile communication device, by SMS text messaging, robotic recorded phone call or by an email message.

While the present discussion has been illustrated and described with reference to specific embodiments, further modification and improvements will occur to those skilled in the art. For example, the computer may combine or package multiple advertisements in multiple forms such as graphics, texts or other forms and deliver codes for special deal in the advertisements. Additionally, computer program or software used herein is any plurality of binary values or any executable, interpreted or compiled computer code which can be used by a computer or execution device such and an embedded computer chip to perform a task. This software, code or program can be written in any one of several known computer languages. A computer, as used herein can mean any device which stores, processes, routes, manipulates, or performs like operation on data. It is understood, therefore, that this disclosure is not limited to the particular forms illustrated and that it is intended in the appended claims to embrace all alternatives, modifications and variations which do not depart from the spirit and scope of the embodiments described herein.

The descriptions and illustrations of embodiments described herein are intended to provide a general understanding of the structure of different embodiments and they are not intended to serve as a complete description of all the elements and features of apparatus, devices or systems that might make use of the structures described herein. Many other embodiments will be apparent to those of skill in the art upon reviewing the description herein. Other embodiments may be realized and derived therefrom, such that structural and logical substitutions and alterations may be made without departing from the scope of this invention disclosure. Figures are used merely as general representations and not drawn to scale nor representative of a real world system.

Although the present specification describes components and functions implemented in the embodiments with reference to particular standards and protocols, the disclosure is not limited to such standards and protocols. each of the standard or protocols herein may not be the latest most up to date versions. Such standards and protocols are frequently superseded by faster, better, more efficient and more advanced equivalents having intrinsically the same functions. Therefore, updated, upgraded, newer more advanced replacement standards and protocols having the same functions are considered equivalents.

While the foregoing is directed to embodiments of the present invention, other and further embodiments of the invention may be devised without departing from the basic scope thereof, and the scope thereof is determined by the claims that follow. The illustration of embodiment described herein are intended to provide a general understanding of the structure of various embodiments and they are not intended to server as a complete description of all the elements and features of apparatus and systems that might make use of the structures described herein. Many other embodiments will be apparent to those skilled in the art upon reviewing the disclosure herein. Combinations of the above embodiments and other embodiments not specifically described herein will be apparent to those of skill in the art upon reviewing the above descriptions.

The disclosure subject material herein is to be considered illustrative and not restrictive and the appended claims are intended to cover all such modifications, enhancements and other embodiments which fall within the true spirit and scope of the present invention. Therefore, to the maximum extent permitted by law, the scope of the present invention is to be determined by the broadest permissible interpretation of the following claims and their equivalents and shall not be restricted or limited by the foregoing detailed description. The foregoing description of preferred embodiments of the present invention has been provided for the purpose of illustration and description. It is not exhaustive or limiting of the invention. Many modifications and variations will be apparent to practitioners skilled in the art.

What is claimed:

1. A method for distribution of media content via a display device, the method operating in one or more computers, comprising:
a. sending information of the display device in communication with one or more communications networks to a computer while traveling with a vehicle;
b. determining whether the display device is within a predetermined range of a target;
c. utilizing a computer comprising: a processor, and software embedded in a non-transitory computer readable medium which when executed by the processor is configured to initiate commands to cause the selection of media content from a storage medium;
d. transmitting said selected media content to the display device via a communications network; and
e. utilizing a computer comprising: a processor, and software embedded in a non-transitory computer readable medium which when executed by the processor is configured to initiate commands to cause the received media content to be presented on a display for viewers.

2. The method of claim 1, further comprising compensating any subset of the following: the vehicle owner, the display device owner, and the display device user.

3. A non-transitory computer readable media comprising code to perform the acts of the method of claim 1, and wherein updating the media content storage, and the target information storage is performed using a device with internet access.

4. The method of claim 1, wherein the display device is in communication with at least one among a communications network, another display device, and a mobile device.

5. The method of claim 1, further comprising sensing the presence of at least one among a vehicle, and a person.

6. The method of claim 1, wherein the location can be determine by at least one among a GPS receiver, and a mobile device.

7. A system for advertising via a display device, comprising:
a. at least one display coupled with the display device, at least one wireless communication access point;
b. a processor, a storage containing a program comprising a non-transitory computer readable medium comprising: code, which when executed by the processor is configured to:
c. send information from the display device to a computer via at least one wireless communications access point;
d. a storage for storing one or more media content files associated with one or more advertisements, and for storing one or more information files on at least one among a business, and a point of interest;
e. a computer coupled to said storage having a connection to at least one wireless communications access point, wherein the computer will process the information and select one or more advertisements from the storage;
f directs said selected advertisements to at least one wireless communications access point to transmit to one or more display devices; and
g. initiates commands to cause the selected advertisements to be presented on at least one display for viewing while traveling with a vehicle.

8. The system of claim 7, wherein the wireless communications access point is from at least one among a satellite network, a cellular network, a WAN, a MAN, a WiMAX network, an IEEE 802 device network, and a WiFi network.

9. The system of claim 7, further comprising, any subset of the following: a security device, a sensor, cellular communication, satellite communication, an image capture device, and telematics.

10. The system of claim 7, wherein the display is any subset of the following: multilingual, portable, alphanumeric, electronic, detachable, removable, and rotatable.

11. The system of claim 7, wherein the display is positioned on a vehicle for viewers outside of the vehicle.

12. The system of claim 7, wherein the advertisement selected is at least one among a location specific advertisement, a general advertisement, a dynamic advertisement and a special deal requirement request matching advertisement.

13. The system of claim 7, further comprising the power supply of the display device is from at least one among vehicle power, its own independent power source, and any combination thereof.

14. A computer implemented method, for conveying media content via a display device, comprising:
a. receiving one or more signals from a global positioning system;
b. processing the said receive signals from the global positioning system;
c. monitoring the location of the display device as it travels with a vehicle;
d. determining whether the display device is within a predetermined range of a target;
e. communicating with a computer via a communications network;
f processing information from the display device with a computer;
g. using a computer to select media content from a computer readable storage media;
h. transmitting the said selected media content to the display device via a communications network;
i. presenting the media content on one or more electronic visual displays;
j. terminating the presentation of the media content.

15. The computer implemented method of claim 14, wherein the display is placed on a vehicle to target a viewing audience which is outside of the vehicle.

16. The computer implemented method of claim 14, wherein the advertisement is at least one of among a text file, an audio file, an image file, and a video file.

17. The computer implemented method of claim 14, further comprising updating the storage by a user with internet access.

18. The computer implemented method of claim 14, wherein the advertisement selected is based on a service level agreement.

19. The computer implemented method of claim 14, wherein the media content presented is location specific.

20. A non-transitory computer readable media comprising code to perform the acts of the method of claim 14, and wherein the communications network comprise of a wireless network.
